(19) United States
(12) Patent Application Publication
(10) Pub. No.: US 2015/0019005 A1
(43) Pub. Date: Jan. 15, 2015

(54) PACKAGING LINE

(71) Applicant: GEA Food Solutions Germany GmbH, Biedenkopf-Wallau (DE)

(72) Inventors: Nelson Moreira da Costa, Biedenkopf (DE); Tilman Naeher, Wiggensbach (DE); Rolf Rein, Breidenbach (DE)

(21) Appl. No.: 14/382,811

(22) PCT Filed: Mar. 5, 2013
(86) PCT No.: PCT/EP2013/054307

§ 371 Date: Sep. 4, 2014

(30) Foreign Application Priority Data
Mar. 7, 2012 (DE) 10 2012 004 341.4

(51) Int. Cl. B65B 57/00; B65G 43/00

(52) U.S. Cl. CPC B65B 57/00; B65G 43/00
USPC 700/230

(57) ABSTRACT

The present invention relates to a packaging line comprising a packaging machine and at least one additional component, wherein the packaging machine and the component each have an at least partially local control and the packaging line has a line regulation/control. The present invention further relates to a method for operating a packaging line comprising a packaging machine and at least one additional component, wherein the packaging machine and each component have an at least partially local control and the packaging line has a line regulation/control.

The present invention relates to a packaging line, preferably a food packaging line, comprising a packaging machine and at least one further component wherein the packaging machine and the component respectively have at least partially a local control system, for example a stored-program controller, and the packaging line has a closed-loop/open-loop line control system. The present invention also relates to a method for operating a packaging line comprising a packaging machine and at least one further component, wherein the packaging machine and each component respectively have at least partially a local closed-loop/open-loop control system and the packaging line has a closed-loop/open-loop line control system.

Such food packaging lines are known from the prior art and are used for packing food, in particular protein-containing food, such as for example cooked meat, cheese or ham, but also fresh meat and the like, in packs. Apart from a packaging machine, for example a form-fill-seal packaging machine (FFS packaging machine) or a so-called tray sealer, such a food packaging line also has at least one further component, which is located upstream and/or downstream of the packaging machine. This may be for example a cutting-up device, a loading device and/or a portioner, which for example divides up and/or forms a mass of minced meat into specific portions, and/or a pack singling machine, which arranges streams of packs arriving in multiple rows into for example a stream of packs of a single row, and/or a detector, with which for example metal foreign bodies included in the pack are detected, and/or a scanner, with which the outer contour and/or the inner structure for example of a block of food are determined. Such food packaging lines may be of a considerable length. In the case of the food packaging lines according to the prior art, the packaging machine and at least partially each further component have a local operator control unit, with which the packaging machine or each further component can be set and at which a fault that has occurred can be acknowledged after it is rectified. Furthermore, the food packaging lines according to the prior art have a line control system with a separate operator control unit, which controls the line and from which the line can be started and/or stopped. In the event of a fault on the packaging machine or a further component, the operating personnel must first make their way to this unit, establish the fault, rectify it and acknowledge it. After that, the operating personnel must make their way to the line control system and start the line again from there. As a result, either the food packaging line is out of action for a considerable time and/or a very large number of personnel have to be kept on standby to allow faults occurring to be rectified quickly.

It was therefore the object of the present invention to provide a packaging line, in particular a food packaging line, and a method for operating a packaging line, in particular a food, packaging line, that do not have the disadvantages of the prior art.

The object is achieved by a packaging line, in particular a food packaging line, comprising a packaging machine and at least one further component, wherein the packaging machine and the component respectively have at least partially a local closed-loop/open-loop control system and the food packaging line has a closed-loop/open-loop line control system, characterized in that the packaging machine and each component respectively have at least partially an operator control unit, and it is provided that the closed-loop/open-loop line control system can be activated from a number of operator control units, preferably from all of them.

The present invention relates to a packaging line, in particular a food packaging line. Such food packaging lines are used for packing food, in particular protein-containing food, such as for example cooked meat, cheese or ham, but also fresh meat and the like, in packs. Apart from a packaging machine, for example a form-fill-seal packaging machine (FFS packaging machine) or a so-called tray sealer, according to the invention the food packaging line also has at least one further component, which is located upstream and/or downstream of the packaging machine. This may be for example a balance, a scanner, with which the outer contour and/or the inner structure for example of a block of food are determined, a cutting-up device, a loading device, and/or a portioner, which for example divides up and/or forms a mass of minced meat into specific portions, and/or a pack singling machine, which arranges streams of packs arriving in multiple rows into for example a stream of packs of a single row, and/or a detector, with which for example metal foreign bodies included in the pack are detected. However, a further component of the food packaging line may also be a labeler or a printer for printing labels.

The closed-loop/open-loop line control system may be part of the local control system or a dedicated unit separate from a component or the packaging machine.

Also according to the invention, the packaging machine and the further component(s) have at least partially a local closed-loop/open-loop control system. These closed-loop/open-loop control systems control the function of the packaging machine or the respective component. According to the invention, there is additionally a closed-loop/open-loop line control system, with which the function of the line is controlled.

According to the invention, the packaging machine and at least partially each component respectively have an operator control unit, for example an operator control panel, and it is provided that the closed-loop/open-loop line control system can be activated from a number of operator control units, preferably from all of them. As a result, it is possible according to the invention to control the food packaging line from each operator control unit. It is similarly possible according to the invention to rectify locally a fault that occurs on the packaging machine or a component and to start the food packaging machine again from this operator control unit. It is accordingly not necessary for the operating personnel for example first to rectify the fault locally and then make their way to the operator control unit of the closed-loop/open-loop line control system, in order to restart the food packaging machine from there. Consequently, the distances that the operating personnel have to cover, for example to rectify a fault, are reduced considerably.

The disclosure made with respect to this subject of the present invention applies equally to the other subjects of the present invention, and vice versa.

A further or a preferred subject of the present invention is a food packaging line in the case of which data from the packaging machine and any other component of the food packaging line can be retrieved from each operator control unit. This embodiment of the present invention that is provided according to the invention or is preferred makes it possible to view status messages of the packaging machine or of another component, and acknowledge fault messages possibly occurring, from the operator control unit of the packaging machine or any other component.

The disclosure made with respect to this subject of the present invention applies equally to the other subjects of the present invention, and vice versa.

A further or a preferred subject of the present invention is a packaging line, in particular a food packaging line, which preferably has an operator control unit, in particular a mobile operator control unit, for the packaging machine and/or each further component. In particular, in the case of this embodiment of the present invention than is provided according to the invention or is preferred, the food packaging line has fewer operator control units than the packaging machine plus component(s). Preferably, the food packaging line that is provided according to the invention or is preferred has just a single operator control unit. This operator control unit is in particular a mobile operator control unit, with which the packaging machine and any other component of the packaging line can be operated and/or programmed and with which the packaging line can be controlled, that is to say for example started and stopped. From the mobile operator control unit, for example, the status of the packaging machine and any other component of the food packaging line can be inquired. Preferably, the mobile operator control unit communicates wirelessly with a transmitting/receiving unit of the food packaging line. Alternatively or additionally, fault messages on the packaging machine or any other component can be acknowledged from the operator control unit. Furthermore, it is possible to use the mobile operator control unit to perform a modification in the formulation. The fact that just one mobile unit is provided means that the food packaging line only has to have one transmitting/receiving unit. This has the result for example that the length of the cabling within the food packaging line can be reduced considerably, and it is possible to do without a number of operator control units.

The disclosure made with respect to this subject of the present invention applies equally to the other subjects of the present invention, and vice versa.

A further or a preferred subject of the present invention is a food packaging line in the case of which the local stored-program controllers exchange data and/or commands bidirectionally. This embodiment of the present invention that is provided according to the invention or is preferred allows that data or commands are exchanged between the local stored-program controllers. This makes it possible to inquire the status of the packaging machine or any other component from the operator control unit of any other component, to acknowledge fault messages and for example to modify the formulation of the food packaging line or control the entire food packaging line, that is to say also start and stop it, from one operator control unit. It is also preferred for it to be possible to access the closed-loop/open-loop line control system from any local closed-loop/open-loop control system.

The disclosure made with respect to this subject of the present invention applies equally to the other subjects of the present invention, and vice versa.

Yet another subject of the present invention is a method for operating a packaging machine, in particular of a food packaging line comprising a packaging machine and at least one further component, wherein the packaging machine and each component respectively have at least partially a local closed-loop/open-loop control system and the food packaging line has a closed-loop/open-loop line control system and in the case of which the packaging machine and the component respectively have at least partially an operator control unit, wherein the packaging machine and at least one further component are controlled, that is to say also started and/or stopped, with each operator control unit.

The disclosure made with respect to this subject of the present invention applies equally to the other subjects of the present invention, and vice versa.

The method according to the invention makes it possible to rectify locally a fault that occurs on the packaging machine or a component, to acknowledge the fault and to start the food packaging line again from this operator control unit. It is accordingly not necessary for the operating personnel first to rectify the fault locally and then make their way to the operator control unit of the closed-loop/open-loop line control system, in order to restart the food packaging line from there. Consequently, the distances that the operating personnel have to cover to rectify a fault are reduced considerably, whereby the operating time of the food packaging line is increased considerably.

The packaging machine and the other component(s) of the packaging machine according to the invention are preferably stopped or started in a specific sequence. The starting and stopping of the packaging line according to the invention are preferably performed in such a way that as little food as possible or fewest possible packs have to be discarded.

A further or preferred subject of the present invention is a method in which each local closed-loop/open-loop control system initiates and/or controls a predefined functional sequence of the food packaging line. The method that is provided according to the invention or is preferred makes it possible to control the food packaging line, in particular start and stop it, from each operator control unit. At the same time or alternatively, modifications to the food packaging method may be performed from each operator control unit. For example, the formulation of the packs to be produced can be modified from each operator control unit.

The disclosure made with respect to this subject of the present invention applies equally to the other subjects of the present invention, and vice versa.

A further or preferred subject of the present invention is therefore a method in which a modification in the formulation is carried out from any desired operator control unit. The formulation no longer has to be modified from the operator control console of the line control system. It may be performed from the operator control unit of the packaging machine or of another component.

The disclosure made with respect to this subject of the present invention applies equally to the other subjects of the present invention, and vice versa.

Preferably, a central formulation management can be accessed from the operator control unit of the packaging machine or any other component. This central formulation management comprises the respective formulation programs for the packaging machine or for each individual component. For example, the programs have different numbers/names and the programs are stored as specifically matching the packaging machine or each individual component. Such a formulation program may for example contain data on which product is to be cut up by a cutting-up device, the weight of the respective portions or the configurations (for example piled up or overlapping) and the kind of packaging in which the respective pack is to be packed. The formulation program may also contain data on how the atmosphere in the pack is to be constituted and/or how the label of the pack is to be designed. Preferably, the open-loop/closed-loop control system of the food packaging machine is designed such that it can only be started when the respective programs are stored in the packaging machine or in the respective component. For the case where a certain tool is required for a specific formulation, starting of the packaging line is preferably only possible when this corresponding tool is installed in the packaging machine or in the component.

In the event of a malfunction, the packaging machine or another component of the food packaging line issues a fault message. After rectifying the fault, the food packaging line is started again at this packaging machine or other component from the operator control unit of the defective packaging machine or component.

A further subject of the present invention is a method for operating a packaging line, in particular a food packaging line, comprising a packaging machine and at least one further component, wherein the food packaging line can be stopped but remains on standby. This mode of the food packaging machine is suitable for example in emergency situations and/or if a consumable material, for example the packaging material and/or a roll of labels, has to be changed. The food packaging line is then stopped, but the cutting blade of a cutting-up device that is possibly present preferably continues to rotate. As a result, the packaging line according to the invention is ready for operation immediately after rectification of the respective malfunction and/or replacement of the consumable material.

The disclosure made with respect to this subject of the present invention applies equally to the other subjects of the present invention, and vice versa.

Yet another subject of the present invention is a method for temporarily running empty a food packaging line comprising a packaging machine and at least one further component located upstream, in the case of which all components are run empty apart from the packaging machine, and all packs filled with a food are closed, but partially remain in the packaging machine and possibly also upstream components.

The disclosure made with respect to this subject of the present invention applies equally to the other subjects of the present invention, and vice versa.

This mode of the method is suitable for example in the case of a breakfast break. The fact that all of the components that are located upstream of the packaging machine are run empty, i.e. freed of food, means that the food cannot be harmed there. Furthermore, all packs in which there is food are closed, so that these food packs can be sold as acceptable packs in spite of the temporary interruption in the packaging process.

A further subject of the present invention is a method for completely running empty a food packaging line comprising a packaging machine and at least one further component located upstream, in the case of which firstly the component located upstream is run completely empty and then all of the pack trays already produced are removed from the packaging machine. After that, usually components located downstream are also run empty.

This mode of the method is suitable in particular at the end of a shift or when there is a change of formulation. All of the components located upstream of the packaging machine are run empty and all of the pack trays that have already been molded into the bottom sheet are removed from the packaging machine. As a result, neither can food be contaminated nor can dust collect in the pack trays, for example overnight, and thereby lead to a hygiene problem.

The disclosure made with respect to this subject of the present invention applies equally to the other subjects of the present invention, and vice versa.

A further subject of the present invention is a method for adapting, in particular dynamically adapting, the speeds of the packaging line comprising a packaging machine and at least one further component located upstream and/or downstream, in the case of which the speeds of all the components are dynamically adapted to one another, that is to say become successively faster or slower, so that the line operates as continuously as possible and/or with optimum effectiveness.

Preferably, this does not involve the speed of all the components being reduced or increased proportionately, but differently.

Preferably, at least one component has a buffer, with which for example slices of food can be buffered. For the case where for example the cutting-up device has to be loaded, this buffer is run empty, so that a packaging machine provided downstream can continue to operate continuously, possibly with a reduced number of cycles, until the cutting-up device is ready to operate again. The slices of food then cut off are at least partially used for refilling the buffer.

For the case where the packaging machine has to be serviced or loaded with new materials, the cutting-up device may continue to cut off slices of food, in particular with a reduced cutting capacity, and fill an existing buffer. This reduced cutting-up capacity is then preferably maintained for a certain time, until the buffer has at least partially been run empty again.

These statements apply analogously for example to a former that produces formed products from a mass, in particular minced meat.

The disclosure made with respect to this subject of the present invention applies equally to the other subjects of the present invention, and vice versa.

This mode of the method is suitable for example whenever the packaging machine has to run as continuously as possible, in order for example not to risk inadmissible overheating of the packaging sheet material during waiting times enforced by other components.

A person skilled in the art appreciates that the described subjects of the present invention apply equally to the case where the control system and operator control unit of the packaging machine are not integrated at all in the packaging line, for example whenever there happens to be an old packaging machine with an old control system provided in a new packaging line, the old control system not being compatible with the closed-loop/open-loop line control system. The descriptions apply equally and similarly to this case, wherein for example then only a food packaging line with a slicer and at least one further component located upstream and/or downstream is provided.

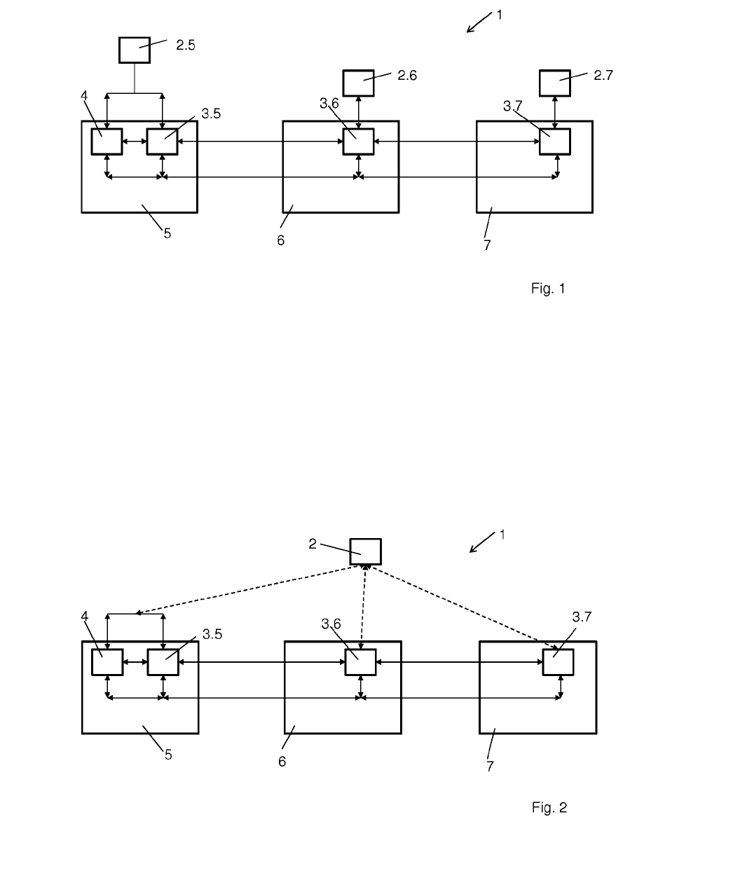

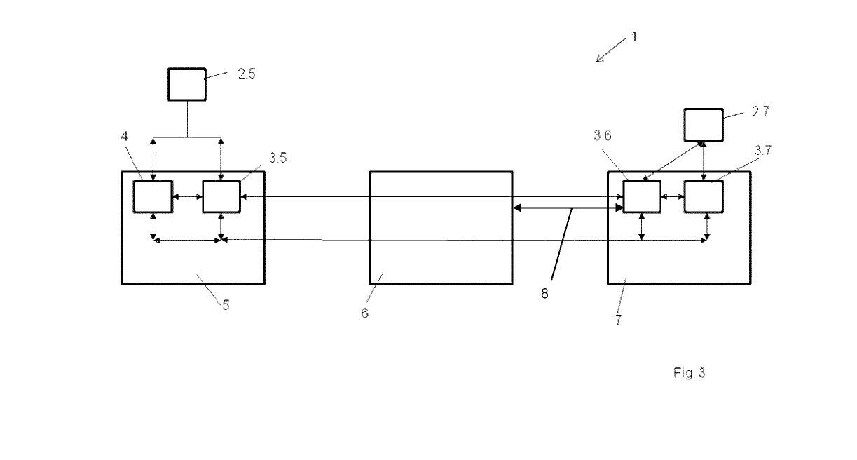

The inventions are explained below on the basis of FIGS. 1 and 2. These explanations are given merely by way of example and do not restrict the general concept of the invention. The explanations apply equally to all of the subjects of the present invention.

FIG. 1 shows a first embodiment of the food packaging line according to the invention.

FIG. 2 shows a further embodiment of the packaging line according to the invention.

FIG. 3 shows a further embodiment of the packaging line according to the invention.

FIG. 1 shows a first embodiment of the food packaging line according to the invention. This has in the present case three components 5, 6, 7. The component 7 is in the present case a packaging machine, in particular a so-called form-fill-seal packaging machine (FFS packaging machine), and the component 5 is for example a cutting-up device, with which a block of food is cut up into slices of food, which are configured into portions of for example ten slices of food each. The component 6 is for example a loader, with which cut-up portions are placed into the pack trays of the packaging machine. Each component 5, 6, 7 has a local stored-program controller (SPC) 3.5, 3.6, 3.7. Furthermore, in the case of the embodiment according to FIG. 1, each component 5, 6, 7 has an operator control unit 2.5, 2.6, 2.7. In addition, the food packaging line 1 according to the invention has a closed-loop/open-loop line control system 4. This closed-loop/open-loop line control system 4 may be part of one of the components 5, 6, 7, but also a separate component/subassembly. As FIG. 1 reveals, data and commands can be respectively exchanged bidirectionally between the local SPCs 3.5, 3.6, 3.7. Furthermore, each local SPC 3.5, 3.6, 3.7 is also connected bidirectionally to the closed-loop/open-loop line control system 4. The closed-loop/open-loop line control system does not have a dedicated operator control unit. According to the invention, it is thus possible to control the entire food packaging line, that is to say start and/or stop it, from each operator control unit. Furthermore, it is possible according to the invention to check the status of all the components 5, 6, 7 of the food packaging line according to the invention, and acknowledge faults that are possibly indicated, from each operator control unit. If, for example, a fault occurs on the packaging machine 7, the operating personnel can rectify the fault there and restart the food packaging line from the operator control unit 2.7. Furthermore, it can be checked from the operator control unit 2.7 whether for example the cutting-up device 5 is functioning properly. A change of formulation can also be initiated from, one of the operator control units 2.5, 2.6, 2.7. This change of formulation is then transmitted to the closed-loop/open-loop line control system, which transmits the corresponding information to the respective components. Furthermore, a modification in the formulation can be initiated from the operator control unit 2.5, 2.6, 2.7, for example if there is a fault in a formulation. This modification of the formulation is then transmitted to the closed-loop/open-loop line control system, which transmits the corresponding information to the respective components. The fact that the open-loop/closed-loop line control system can be addressed from each operator control unit and/or that the food packaging line according to the invention can be controlled, that is to say for example started and/or stopped, from each operator control unit, means that the operating personnel are spared from going considerable distances, for example in the event of a malfunction of the packaging line according to the invention. If, for example, the food packaging line according to the invention is to be temporarily run empty in the case of a breakfast break, a corresponding command can be entered into one of the operator control units 2.5, 2.6, 2.7. The food packaging line according to the invention is then preferably programmed such that the components 5, 6 are run completely empty, i.e. all of the blocks of food present in the cutting-up device are cut up completely into portions, and any remaining pieces that may be present are disposed of. After that, all of the complete portions that are located on the loader 6 are placed into the pack trays, which have for example been molded into a web of sheet material in the packaging machine, until the loader 6 has also been emptied completely. Incomplete portions, i.e. underweight portions, are preferably disposed of. Furthermore, all of the pack trays in the packaging machine in which there are slices of food are closed, so that they are not contaminated during the breakfast break. For the case where the pack trays of one format cannot be completely filled with slices of food, several packs are nevertheless closed with a cover sheet as so-called empty packs and subsequently discarded. After the breakfast break, the food packaging line according to the invention can then be started up again, by a block of food being placed into the cutting-up device and cut up. If, on the other hand, the food packaging according to the invention is to be shut down for a lengthy period of time, for example overnight, not only are the components 5, 6 run completely empty, but also all of the pack trays molded into the web of sheet material are removed from the packaging machine. Such a complete stop of the packaging line according to the invention may also be used for example for a change of format.

In FIG. 2, substantially the same embodiment of the food packaging line according to FIG. 1 is represented, with the difference that in the present case all of the components have just one operator control unit. This makes it possible to do without considerable lengths of cabling and the respective operator control units. The operator control unit 2 is preferably a mobile operator control unit, for example a tablet computer. This operator control unit 2 is preferably connected wirelessly to the food packaging line 1 according to the invention. For this purpose, the food packaging line according to the invention preferably has a transmitting/receiving unit, which can communicate bidirectionally, preferably wirelessly, with the operator control unit 2. From this operator control unit 2, all of the components of the food packaging line can be controlled, that is to say for example started and stopped. Furthermore, the status of each component can be inquired, and any possible corrections to the respective component can be made.

In FIG. 3, substantially the same embodiment of the food packaging line according to FIG. 1 is represented, with the difference that in the present case no dedicated control system is provided for the component 6. The control system 3.6 of the component 6 is integrated here in the component 7 and is operated from the operator control unit 2.7 of the latter. The data/command exchange between the component 6 and the control system 3.6 is symbolized by the double-headed arrow 8. A person skilled in the art appreciates that the control systems 3.6, 3.7 may be one unit.

### LIST OF DESIGNATIONS

1 food packaging line

2 operator control unit, mobile operator control unit

2.5 operator control unit

2.6 operator control unit

2.7 operator control unit

3.5 local control system, local stored-program controller, local SPC

3.6 local control system, local stored-program controller, local SPC

3.7 local control system, local stored-program controller, local SPC

4 closed-loop/open-loop line control system

5 component of the line

6 component of the line

7 component of the line, packaging machine

8 data/command transfer between the component and the local control system

What is claimed is:

1. A packaging line comprising:
a packaging machine and
at least one further component,
wherein the packaging machine and the component respectively have at least partially a local control system, and the food packaging tine has a closed-loop/open-loop line control system,
wherein the packaging machine and each component respectively have at least partially an operator control unit, and the closed-loop/open-loop line control system can be activated from a number of operator control units from all of the operator control units.

2. The packaging line according to claim 1, wherein data from the packaging machine and any other component of the food packaging line can be retrieved from each operator control unit.

3. The packaging line according to claim 1, wherein the packaging line has an operator control unit that is a mobile operator control unit, for the packaging machine and each further component.

4. The packaging line according to claim 1, wherein the local control systems exchange data and/or commands bidirectionally.

5. A method for operating a packaging line comprising:
a packaging machine and
at least one further component,
wherein the packaging machine and each component respectively have at least partially a local control system and the food packaging line has a closed-loop/open-loop line control system,
the packaging machine and the component respectively have at least partially an operator control unit and in that the packaging machine and at least one further component are controlled, that is to say also started and/or stopped, with each operator control unit.

6. The method as claimed in claim 5, wherein the packaging machine and the further component are stopped or started in a specific sequence.

7. The method as claimed in claim 5, wherein each local control system initiates and/or controls a pre-defined functional sequence.

8. The method as claimed in one of the preceding claims or according to the preamble of patent claim 5, wherein a modification in the formulation is carried out from any desired operator control unit.

9. The method as claimed in claim 5, wherein the packaging machine or another component issues a fault message and in that, after rectifying the fault, the food packaging line is started again at this packaging machine or other component from the operator control unit of the defective packaging machine or component.

10. The method as claimed in claim 5, wherein a fault message on the packaging machine or another component is acknowledged from any desired operator control unit.

11. The method as claimed in claim 5, wherein status inquiries of the packaging machine or another component are inquired from any desired operator control unit.

12. A method for operating the packaging line of claim 1, wherein the packaging line is is stopped but remains on standby.

13. A method for temporarily running empty the packaging line of claim 1, wherein the packaging machine and the at least one further component is located upstream and/or downstream,
wherein all upstream components are run empty apart from the packaging machine, and all packs filled with a food are closed, but partially remain in the packaging machine.

14. A method for completely running empty a packaging line comprising:
a packaging machine and
at least one further component located upstream and/or downstream,
wherein firstly the component located upstream is run completely empty and then all of the pack trays already produced are removed from the packaging machine.

15. The method as claimed in claim 6, wherein the packaging machine or another component issues a fault message and in that, after rectifying the fault, the food packaging line is started again at this packaging machine or other component from the operator control unit of the defective packaging machine or component.

16. The method as claimed in claim 7, wherein the packaging machine or another component issues a fault message and in that, after rectifying the fault, the food packaging line is started again at this packaging machine or other component from the operator control unit of the defective packaging machine or component.

17. The method as claimed in claim 6, wherein a fault message on the packaging machine or another component is acknowledged from any desired operator control unit.

18. The method as claimed in claim 7, wherein a fault message on the packaging machine or another component is acknowledged from any desired operator control unit.

19. The method as claimed in claim 6, wherein status inquiries of the packaging machine or another component are inquired from any desired operator control unit.

20. The method as claimed in claim 18, wherein status inquiries of the packaging machine or another component are inquired from any desired operator control unit.
